(19) United States
(12) Patent Application Publication
(10) Pub. No.: US 2013/0008625 A1
(43) Pub. Date: Jan. 10, 2013

(54) BINDER COMPOSITION FOR USE IN MOLD MANUFACTURING

(75) Inventors: Akira Yoshida, Toyohashi-shi (JP); Toshiki Matsuo, Toyohashi-shi (JP)

(73) Assignee: KAO CORPORATION, Tokyo (JP)

(21) Appl. No.: 13/635,633

(22) PCT Filed: Mar. 18, 2011
(86) PCT No.: PCT/JP2011/056581

§ 371 Date: Sep. 17, 2012

(30) Foreign Application Priority Data
Mar. 18, 2010 (JP) 2010-062946

(51) Int. Cl. C08L 75/02; C08K 3/22; C08K 3/32; C08K 5/098; C08K 5/42; B22C 1/16; C08K 3/28

(52) U.S. Cl. 164/527; 524/436; 524/437; 524/429; 524/400; 524/396; 524/161; 524/356; 524/435; 524/413; 524/417

(57) ABSTRACT

The present invention provides a binder composition for use in mold manufacturing that is capable of preventing a deterioration in the mold strength in a high-humidity environment, and further restraining the generation of an irritant gas at the time of casting; and a mold manufacturing composition wherein this binder composition is used. In order to provide such the binder composition, the binder composition for use in mold manufacturing, comprises a furan resin, and a metal compound containing one or more metal elements selected from the group consisting of elements in the Groups 2, 4, 7, 10, 11 and 13 of the periodic table, wherein the content by percentage of the metal element(s) in the binder composition is from 0.01 to 0.70% by weight, and the metal compound is one or more metal compounds selected from hydroxides, nitrates, oxides, organic acid salts, alkoxides, and ketone complexes.

### TECHNICAL FIELD

The present invention relates to a binder composition for use in mold manufacturing which contains a furan resin and a metal compound, and a mold manufacturing composition wherein this binder composition is used.

### BACKGROUND ART

An acid-curable self-curing mold is manufactured by adding, to fire-resistant particles made of silica sand or some other, a binder for use in mold manufacturing that contains an acid-curable resin, and a curing agent that contains an organic sulfonic acid, sulfuric acid, phosphoric acid or some other, kneading these components, filling the resultant casting sand into an original pattern such as a woody mold, and then curing the acid-curable resin. The acid-curable resin used may be a furan resin, a phenolic resin or some other resin. The furan resin may be furfuryl alcohol, furfuryl alcohol/urea-formaldehyde resin, furfuryl alcohol/formaldehyde resin, furfuryl alcohol/phenol/formaldehyde resin, any other known modified furan resin, or some other resin. The resultant mold is used at the time of casting for a mechanical component casting, a construction machine component, an automobile component, or some other casting.

Examples of an item significant for the manufacturing of the mold, or casting for a desired casting by use of the mold include a deterioration in the mold strength, and a working environment at the time of the casting. The deterioration in the mold strength may become a problem, in particular, when the mold is stocked over a long term in a high-humidity environment at the time of rainy weather, a rainy season or the like. In other words, it is feared that the mold is cracked, or at the time of casting, the core may be cracked sc that the resultant casting may be a defective product.

In connection with the working environment at time of casting, a sulfur compound, such as an organic sulfonic acid or sulfuric acid, is used as a curing agent in the manufacturing of an acid-curable self-curing mold; thus, the working environment may be deteriorated, in particular, by sulfur dioxide gas, or other irritant gases (such as hydrogen chloride gas) originating from an additive, such as a chloride, at the time of casting.

It is therefore desired co improve a deterioration in the mold strength in a high-humidity environment, and improve a deterioration in the working environment that is caused by the generation of sulfur dioxide gas, hydrogen chloride gas and other irritant gases at the time of casting.

Patent Document 1 suggests a furan-resin-containing molding sand to which a chloride of an alkaline earth metal and a chloride of a zinc-group element are added in order to promote the curing of the molding sand. Patent Document 2 suggests a molding sand wherein a binder and anhydrous sodium carbonate are blended with silica sand, or a molding sand wherein a binder, anhydrous calcium chloride and anhydrous sodium carbonate are blended with silica sand in order that about gas which contains extraordinarily bad smell generated by casting a molten metal into a mold, the smell can be decreased, or burned fume which contains the same smell can be decreased. Patent Document 3 suggests a binder composition for use in mold manufacturing that contains an acid-curable resin and a metal chloride in order to improve a mold in strength. Patent Document 4 suggests that in order to decrease free formaldehyde from a produced furan resin, an oxide of lead or zinc and a salt thereof are used in a producing catalyst for the resin.

### PRIOR ART DOCUMENTS

### Patent Documents

Patent Document 1: JP-A-48-56520

Patent Document 2: JP-A-8-57575

Patent Document 3: JP-A-2010-29905

Patent Document 4: GB Patent No. 1303707

### DISCLOSURE OF THE INVENTION

### Problems to be Solved by the Invention

However, investigations made by the inventors have made it evident that when a mold is manufactured by any one of the methods described in Patent Documents 1 to 3, sulfur dioxide gas or hydrogen chloride gas is generated in accordance with conditions therefor so that an intensely irritant smell thereof deteriorates the working environment remarkably. Moreover, the investigations made by the inventors have made it evident that when a mold is manufactured by any one of the methods described in Patent Documents 1 to 3, the mold may be deteriorated in strength in accordance with conditions therefor while stocked in a high-humidity environment or caused to undergo some other operation. According to Patent Document 4, in order to decrease free formaldehyde from a furan resin, an oxide of lead or zinc and a salt thereof are added to a producing catalyst for the furan resin to give a specified concentration, and then the resultant catalyst is used to improve the working environment only against the generation of formaldehyde. However, this method is not a method of decreasing sulfur dioxide gas or hydrogen chloride gas to improve the working environment.

The present invention provides a binder composition for use in mold manufacturing that is capable of preventing a deterioration in the mold strength in a high-humidity environment, and further restraining the generation of an irritant gas at the time of casting; and a mold manufacturing composition wherein this binder composition is used.

### Means for Solving the Problems

The binder composition of the invention for use in mold manufacturing is a binder composition for use in mold manufacturing which comprises a furan resin, and a metal compound containing one or more metal elements selected from the group consisting of elements in the Groups 2, 4, 7, 10, 11 and 13 of the periodic table, wherein the content by percentage of the metal element(s) in the binder composition is from 0.01 to 0.70% by weight, and the metal compound is one or more metal compounds selected from hydroxides, nitrates, oxides, organic acid salts, alkoxides, and ketone complexes.

The mold manufacturing composition of the invention is a mold manufacturing composition comprising a mixture of fire-resistant particles, the binder composition of the invention for use in mold manufacturing, and a curing agent for furan resin that is to cure the binder composition for use in mold manufacturing.

### Effect of the Invention

According to the binder composition for use in mold manufacturing, and the mold manufacturing composition according to the invention, the mold can be prevented from being deteriorated in strength in a high-humidity environment, and further the generation of an irritant gas can be restrained at the time of casting.

### MODE FOR CARRYING OUT THE INVENTION

The binder composition for use in mold manufacturing (hereinafter referred to merely as the “binder composition” as the case may be) of the invention is a composition used as a binder when a mold is manufactured. Hereinafter, a description will be made about components contained in the binder composition of the invention.

<Furan Resin>

The furan resin may be, for example, one selected from the group consisting of furfuryl alcohol, any condensate from furfuryl alcohol, any condensate from furfuryl alcohol and an aldehyde, any condensate from furfuryl alcohol and urea, any condensate from furfuryl alcohol, a phenolic compound, and an aldehyde, any condensate from furfuryl alcohol, melamine, and an aldehyde, and any condensate from furfuryl alcohol, urea, and an aldehyde; or a mixture of two or more selected from this group. The furan resin may also be a co-condensate of two or more selected from this group. Furfuryl alcohol can be produced from plants, which are non-petroleum-resources. Thus, it is preferred also from the viewpoint of the global environment to use the furan resins listed up above. It is preferred from the viewpoint of costs and the mold strength to use any condensate from furfuryl alcohol, urea and an aldehyde. This aldehyde is more preferably formaldehyde.

Examples of any one of the above-mentioned aldehydes include formaldehyde, paraformaldehyde, acetaldehyde, glyoxal, furfural, and terephthalaldehyde. One or more of these aldehydes maybe appropriately used. It is preferred from the mold strength to use formaldehyde. From the viewpoint of a decrease in the generation amount of formaldehyde when a mold is manufactured, it is preferred to use furfural or terephthalaldehyde.

Examples of the above-mentioned phenolic compound include phenol, cresol, resorcin, bisphenol A, bisphenol C, bisphenol E, and bisphenol F. One or more of these compounds may be used.

Concrete examples of the furan resin include KAO LIGHTNER EF-5501 manufactured by Kao-Quaker Co., Ltd. (solution of furfuryl alcohol/urea-formaldehyde resin in furfuryl alcohol), and other commercially available products.

The content by percentage of the furan resin in the binder composition is preferably from 55 to 99.9% by weight, more preferably from 60 to 90% by weight, even more preferably from 65 to 85% by weight in order to cause the mold to express a sufficient strength.

<Metal Compound>

The binder composition of the invention contains a metal compound containing one or more metal elements selected from the group consisting of elements in the Groups 2, 4, 7, 10, 11 and 13 of the periodic table in order to prevent the mold strength from being deteriorated in a high-humidity environment, and restrain the generation of an irritant gas at the time of casting. The metal compound has bivalence, or a higher valence; in order to improve the mold strength, it is assumed that the bonding between its fire-resistant particles and its furan resin is made stronger. Thus, it appears that the mold strength can be prevented from being deteriorated in a high-humidity environment. It is also assumed that the metal compound reacts with generated SO₂ to produce an insoluble metal sulfate, such as CaSO₄, and this sulfate is stable against heat so that at the time of casting, the generation of an irritant gas can be restrained. It is also considered that the metal compound in the invention contains no chloride so that an irritant gas of hydrogen chloride is not generated. Examples of the metal element (s) include Mg, Ca, Sr and Ba in the Group 2, Ti and Zr in the Group 4, Mn in the Group 7, Ni in the Group 10, Cu in the Group 11, and B and Al in the Group 13. The metal element (s) is/are in particular preferably one or more metal elements selected from the group consisting of elements in the Groups 2, 7, 10, 11 and 13, more preferably one or more metal elements selected from the group consisting of elements in the Groups 2, 7, 11 and 13, even more preferably one or more metal elements selected from the group consisting of elements in the Group 2 from the viewpoint of reacting with sulfur dioxide to decrease the smell. For the same viewpoint, concrete examples of the metal element (s) are preferably Mg, Ca, Ba, Ti, Zr, Mn, Ni, Cu and Al, more preferably Mg, Ca, Mn, Cu and Al, even more preferably Mg and Ca.

From the viewpoint of preventing the mold strength from being deteriorated in a high-humidity environment, the metal element(s) is/are preferably one or more metal elements selected from the group consisting of elements in the Groups 2, 4, 7, 10, 11 and 13 of the periodic table, more preferably one or more metal elements selected from the group consisting of elements in the Groups 2, 7, 10, 11 and 13, even more preferably one or more metal elements selected from the group consisting of elements in the Groups 2, 7, 11 and 13, even more preferably one or more metal elements selected from the group consisting of elements in the Group 2. From the same viewpoint, concrete examples of the metal element(s) are preferably Mg, Ca, Ba, Ti, Zr, Mn, Ni, and CuAl, more preferably Mg, Ca, Mn, Cu and Al, even more preferably Mg and Ca.

The metal compound used in the invention is one or more metal compounds selected from hydroxides, nitrates, oxides, organic acid salts, alkoxides, and ketone complexes from the viewpoint of preventing the mold strength from being deteriorated in a high-humidity environment and restraining the generation of irritant gases (in particular, sulfur dioxide gas and hydrogen chloride gas) at the time of casting. From the same viewpoint, the metal compound is preferably selected from hydroxides and nitrates. In the invention, one of these compounds, or a combination of two or more thereof may be used. About the metal element also, one species or a combination of two or more species may be used. The metal compound may be used in the form of a hydrate. The metal compound is more preferably one or more hydroxides from the viewpoint of an improvement in the solubility of the metal compound in the binder composition, and from the viewpoint of producing a mold stably for stability so as to restrain a deterioration in the mold strength and the generation of irritant gases.

Concrete examples of the hydroxides usable as the metal compound include calcium hydroxide, magnesium hydroxide, aluminum hydroxide, copper hydroxide, and the like. From the viewpoint of an improvement in the solubility, and from the viewpoint of producing a mold stably for an improvement in stability so as to restrain a deterioration in the mold strength and the generation of irritant gases, calcium hydroxide, magnesium hydroxide and aluminum hydroxide are preferred, calcium hydroxide and magnesium hydroxide are more preferred, and calcium hydroxide is even more preferred. Examples of the nitrates include calcium nitrate, magnesium nitrate, aluminum nitrate, copper nitrate, and the like. Examples of the oxides include calcium oxide, magnesium oxide, and the like. The organic acid salts are preferably organic carboxylic acid salts, and organic sulfonic acid salts from the viewpoint of restraining the generation of sulfur dioxide gas. Examples thereof include calcium lactate, magnesium lactate, calcium acetate, magnesium acetate, calcium formate, magnesium formate, calcium benzoate, magnesium salicylate, and the like, and other organic carboxylic acid salts. Other examples thereof include calcium methanesulfonate, calcium p-toluenesulfonate, calcium xylenesulfonate, and the like, and other organic sulfonic acid salts. Examples of the alkoxides include diethoxyaluminum, diethoxycalcium, diethoxymagnesium, and the like. Examples of the ketone complexes include aluminum di(s-butoxide)acetoacetate, as is used as an aluminum chelating agent, magnesium acetylacetone, calcium acetylacetone, and the like. The use of the ketone complexes rather than the alkoxides is preferred from the viewpoint of handling safety, and dissolution rate into the furan resin. From the viewpoint of preventing the mold strength from being deteriorated in a high-humidity environment, and restraining the generation of irritant gases (in particular, sulfur dioxide gas and hydrogen chloride gas) at the time of casting, the following are preferred: calcium hydroxide, magnesium hydroxide, aluminum hydroxide, calcium oxide, magnesium oxide, calcium nitrate, magnesium nitrate, aluminum nitrate, calcium formate, calcium benzoate, aluminum di(s-butoxide)acetoacetate, magnesium acetylacetone, and calcium acetylacetone. More preferred are calcium hydroxide, magnesium hydroxide, calcium nitrate, magnesium nitrate, and aluminum nitrate, even more preferred are calcium hydroxide and magnesium hydroxide, and even more preferred is calcium hydroxide.

The method for the addition of the metal compound is not particularly limited. Thus, when or after the furan resin is synthesized, the metal compound may be added thereto. When a condensation reaction is conducted in the presence of the metal compound in the step of synthesizing the furan resin, the condensation reaction may be conducted in the same way as used in a case where the metal compound is not present.

The content by percentage of the metal compound in the binder composition is adjusted to set the content by percentage of the metal element (s) in the binder composition into the range of 0.01 to 0.70% by weight from the viewpoint of compatibility between the prevention of a deterioration in the mold strength in a high-humidity environment, and the restraint of the generation of irritant gases at the time of casting. From the same viewpoint, the content by percentage of the metal compound is adjusted to set the content by percentage of the metal element (s) in the binder composition preferably to 0.02% or more by weight, more preferably to 0.05% or more by weight, even more preferably to 0.10% or more by weight, even more preferably to 0.30% or more by weight. In order to keep certainly a good dispersibility or solubility of the metal compound in the furan resin to prevent a deterioration in the mold strength in a high-humidity environment, the content by percentage of the metal compound is adjusted to set the content by percentage of the metal element(s) in the binder composition preferably to 0.05% or less by weight, more preferably to 0.40% or less by weight. Considering the above-mentioned viewpoints synthetically, the content by percentage of the metal compound is adjusted to set the content by percentage of the metal element(s) in the binder composition into the range preferably from 0.02 to 0.70% by weight, more preferably from 0.30 to 0.70% by weight, even more preferably from 0.30 to 0.50% by weight, even more preferably from 0.30 to 0.40% by weight.

When the content by percentage of the metal element(s) in the binder composition of the invention is in the above-mentioned range, the content by percentage of the metal compound is varied in accordance with the species of the metal compound. When the metal compound is, for example, a hydroxide, the content by percentage of the metal compound in the binder composition is preferably from 0.02 to 1.80% by weight, more preferably from 0.18 to 1.80% by weight, even more preferably from 0.50 to 1.80% by weight, even more preferably from 0.50 to 1.30% by weight from the viewpoint of compatibility between the prevention of a deterioration in the mold strength and the restraint of the generation of irritant gases at the time of casting. When the metal compound is a nitride, the content by percentage in the binder composition is preferably from 0.05 to 5.50% by weight, more preferably from 0.50 to 5.50% by weight, even more preferably from 1.80 to 5.50% by weight, even more preferably from 1.80 to 4.00% by weight from the same viewpoint.

<Curing Accelerator>

The binder composition of the invention may contain a curing accelerator to improve the mold strength. From the mold-strength-improving viewpoint, the curing accelerator is preferably one or more selected from the group consisting of any compound represented by a general formula (1) illustrated below (hereinafter referred to as the curing accelerator (1)), any phenol derivative, and any aromatic dialdehyde. The curing accelerator may be contained as a component as the furan resin.

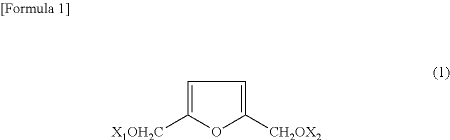

wherein X₁ and X₂ are each a hydrogen atom, CH₃ or C₂H₅.

Examples of the curing accelerator (1) include 2,5-bishydroxymethylfuran, 2,5-bismethoxymethylfuran, 2,5-bisethoxymethylfuran, 2-hydroxymethyl-5-methoxymethylfuran, 2-hydroxymethyl-5-ethoxymethylfuran, and 2-methoxymethyl-5-ethoxymethylfuran. From the viewpoint of improving the mold strength, it is preferred to use, out of these examples, 2,5-bishydroxymethylfuran. From the viewpoint of the solubility of the curing accelerator (1) in the furan resin, and from that of improving the mold strength, the content by percentage of the curing accelerator (1) in the binder composition is preferably from 0.5 to 63% by weight, more preferably from 1.8 to 50% by weight, even more preferably from 2.5 to 50% by weight, even more preferably from 3.0 to 40% by weight.

Examples of the phenol derivative include resorcin, cresol, hydroquinone, phloroglucinol, and methylenebisphenol. Of these examples, preferred are resorcin and phloroglucinol from the viewpoint of improving the mold strength. From the viewpoint of the solubility of the phenol derivative in the furan resin, and from the viewpoint of improving the mold strength, the content by percentage of the phenol derivative in the binder composition is preferably from 1.5 to 25% by weight, more preferably from 2.0 to 15% by weight, even more preferably from 2.0 to 10% by weight.

Examples of the aromatic dialdehyde include terephthalaldehyde, phthalaldehyde, and isophthalaldehyde; and derivatives thereof. The derivatives each denotes an aromatic compound having two formyl groups and having, on the aromatic ring thereof as a basic skeleton, a substituent such as an alkyl group; or the like. From the viewpoint of improving the mold strength, preferred are terephthalaldehyde, and derivatives of terephthalaldehyde. More preferred is terephthalaldehyde. The content by percentage of the aromatic dialdehyde in the binder composition is preferably from 0.1 to 15% by weight, more preferably 0.5 to 10% by weight, even more preferably from 1 to 5% by weight from the viewpoint of dissolving the aromatic dialdehyde in the furan resin sufficiently, improving the mold strength, and restraining a bad smell of the aromatic dialdehyde itself.

<Water>

The binder composition of the invention may further contain water. In the case of synthesizing a condensate that may be of various species, for example, a condensate from furfuryl alcohol and an aldehyde, raw materials in an aqueous solution form is used or condensation water is generated so that the condensate is usually obtained in the form of a mixture thereof with water. When this condensate is used for the binder composition, it is unnecessary to dare to remove the water originating from the synthesis process. Moreover, for the adjustment of the viscosity of the binder composition to an easily-handleable viscosity, or some other purpose, water may be further added thereto. However, if the water amount becomes excessive, the curing reaction of the furan resin may be unfavorably hindered. Thus, the water content by percentage in the binder composition is set into the range of 0.5 to 30% by weight. From the viewpoint of making the handleability of the binder composition high and maintaining the rate of the curing reaction, the content by percentage ranges preferably from 1 to 10% by weight, more preferably from 3 to 7% by weight. From the viewpoint of improving the mold strength, the content by percentage is preferably 10% or less by weight, more preferably 7% or less by weight, even more preferably 4% or less by weight.

<Other Additives>

The binder composition may further contain a silane coupling agent, and other additives. When the composition contains, for example, a silane coupling agent, the resultant mold can be favorably improved in strength. Usable examples of the silane coupling agent include aminosilanes such as N-β-(aminoethyl)-γ-aminopropylmethyldimethoxysilane, N-β-(aminoethyl)-γ-aminopropyltrimethoxysilane, N-P-(aminoethyl)-γ-aminopropyltriethoxysilane, 3-aminopropyltrimethoxysilane, N-β-(aminoethyl)-α-aminopropyltrimethoxysilane, and the like, epoxysilanes such as 3-glycidoxypropyltrimethoxysilane, 3-glycidoxypropyltriethoxysilane, 3-glycidoxypropylmethyldiethoxysilane, 3-glycidoxypropyltriethoxysilane, and the like, ureidosilanes, mercaptosilanes, sulfidesilanes, methacryloxysilanes, and acryloxysilanes. Preferred are aminosialnes, epoxysilanes, and ureidosilanes. The content by percentage of the silane coupling agent in the binder composition is preferably from 0.01 to 0.5% by weight, more preferably form 0.05 to 0.3% by weight from the viewpoint of the mold strength. The silane coupling agent may be contained as a component as the furan resin.

The binder composition of the invention is suitable for a method for manufacturing a mold, which comprises filling, into an original pattern for mold manufacturing, a mold manufacturing composition (molding sand) comprising a mixture of fire-resistant particles, a binder composition for use in mold manufacturing, and a curing agent for furan resin that is to cure the binder composition for use in mold manufacturing, thereby curing the mold manufacturing composition. In short, the mold manufacturing composition of the invention is a mold manufacturing composition in which the above-mentioned binder composition of the invention is used as a binder composition for use in mold manufacturing.

Usable examples of the fire-resistant particles include silica sand, chromite sand, zircon sand, olivine sand, alumina sand, mullite sand, and synthetic mullite sand. Other usable examples thereof include particles obtained by collecting used fire-resistant particles, and particles obtained by subjecting used fire-resistant particles to regenerating treatment.

The curing agent for furan resin may be one or more kind of acidic aqueous solutions each containing a sulfonic acid based compound, such as xylenesulfonic acid (in particular, m-xylenesulfonic acid) or toluenesulfonic acid (in particular, p-toluenesulfonic acid), a phosphoric acid compound, sulfuric acid, or some other acid; and others. When a conventional curing agent for furan resin contains a sulfur compound, such as a sulfonic acid based compound or sulfuric acid, to improve the curing rate, sulfur dioxide gas is generated at the time of casting, so that a working environment therefor is remarkably deteriorated. In the invention, however, the use of the above-mentioned binder composition makes it possible to restrain the generation of sulfur dioxide gas.

When the curing agent for furan resin contains a sulfur compound in the mold manufacturing composition of the invention, the content of the metal element(s) in the binder composition is preferably 0.0005 mole or more, more preferably 0.001 mole or more, even more preferably 0.005 mole or more per mole of the sulfur element in the curing agent for furan resin from the viewpoint of restraining the generation of sulfur dioxide gas. From the viewpoint of improving the dispersibility or solubility of the metal compound used in the invention in the furan resin to yield an even mold, thereby preventing the mold strength from being deteriorated, the content of the metal element(s) in the binder composition is preferably 0.4 mole or less, more preferably 0.3 mole or less, even more preferably 0.2 mole or less per mole of the sulfur element in the curing agent for furan resin. Considering these viewpoints synthetically, the content of the metal element (s) in the binder composition is from 0.0005 to 0.4 mole, more preferably from 0.001 to 0.3 mole, even more preferably from 0.005 to 0.2 mole per mole of the sulfur element in the curing agent for furan resin.

When the curing agent for furan resin contains a sulfur compound, it is preferred that this curing agent further contains a phosphoric acid compound, such as phosphoric acid or a phosphate or the like from the viewpoint of restraining the generation of sulfur dioxide gas further at the time of casting while the mold strength is maintained. More preferably, monoethyl phosphate or diethyl phosphate, which is a phosphate, is used together, thereby making it possible to prevent a deterioration in the hygroscopicity of the mold. In this case, the ratio by mole of the phosphorous element in the phosphoric acid compound to the sulfur element in the sulfur compound (phosphorous/sulfur) is preferably from 0.1 to 10, more preferably from 1 to 5, even more preferably from 2 to 4 from the same viewpoint. Furthermore, according to the additional incorporation of the phosphoric acid compound into the sulfur-compound-containing curing agent for furan resin makes, it is recognized that improvement is made against defects caused by sulfur in the resultant mold, that is, a hot crack in steel of the casting, a poor spheroidization of graphite in the constitution of ductile casting iron, and other inconveniences.

The following may be further incorporated into the curing agent for furan resin: one or more solvents selected from the group consisting of alcohols, ether alcohols and esters, and one or more carboxylic acids. Of these components, preferred are alcohols, and ether alcohols, and more preferred are ether alcohols from the viewpoint of improving the mold strength. The incorporation of the solvent (s) and/or the carboxylic acid(s) also attains a decrease in the water content in the curing agent for furan resin to make the mold strength higher. The content by percentage of the solvent (s) and/or the carboxylic acid (s) in the curing agent is preferably from 5 to 50% by weight, more preferably from 10 to 40% by weight from the viewpoint of improving the mold strength. It is preferred for a decrease viscosity in the curing agent for furan resin to incorporate methanol or ethanol thereinto.

For an improvement of the mold strength, the alcohols are preferably propanol, butanol, pentanol, hexanol, heptanol, octanol, and benzyl alcohol; the ether alcohols are preferably ethylene glycol monoethyl ether, ethylene glycol monobutyl ether, ethylene glycol monohexyl ether, diethylene glycol monoethyl ether, diethylene glycol monobutyl ether, diethylene glycol monohexyl ether, diethylene glycol monophenyl ether, and ethylene glycol monophenyl ether; and the esters are preferably butyl acetate, butyl benzoate, ethylene glycol monobutyl ether acetate, and diethylene glycol monobutyl ether acetate. For an improvement of the mold strength, and a decrease in smell, the carboxylic acids are preferably carboxylic acids each having a hydroxyl group, more preferably lactic acid, citric acid, and malic acid.

The ratio between the fire-resistant particles, the binder composition and the curing agent for furan resin in the molding sand may be appropriately set. For 100 parts by weight of the fire-resistant particles, the content of the binder composition and that of the curing agent for furan resin are from 0.5 to 1.5 parts by weight, and from 0.07 to 1 part by weight, respectively. When the ratio is such a ratio, a mold having a sufficient strength is easily obtained. For 100 parts by weight of the furan resin in the binder composition, the content of the curing agent for furan resin is preferably from 10 to 80 parts by weight, more preferably from 20 to 7 0 parts by weight, even more preferably from 30 to 60 parts by weight for reducing water contained in the mold as much as possible, and for the efficiency of the mixing in a mixer.

When the mold manufacturing composition of the invention is used to manufacture a mold, the manufacture of the mold can be attained by use of a process of a conventional mold-manufacturing method. For example, the mold may be yielded by: adding, to the fire-resistant particles, the binder composition of the invention and the curing agent for furan resin, for curing this binder composition; kneading these components in a batch mixer, a continuous mixer, or some other to prepare a mold manufacturing composition (molding sand); filling this composition into a mold-manufacturing original pattern, such as a woody mold; and then curing the mold manufacturing composition. In this mold-manufacturing method, it is preferred to add the curing agent to the fire-resistant particles, and subsequently add the binder composition of the invention thereto in order to keep the bench life (of the composition) certainly.

### EXAMPLES

Hereinafter, a description will be made about working examples for demonstrating the invention specifically, and the like.

<Preparation of Furan Resin A>

The following was used as a furan resin A described in each of Tables 1 to 3: a resin obtained by dissolving resorcin into a solution, KAO LIGHTNER EF-5501 manufactured by Kao-Quaker Co., Ltd. (solution of furfuryl alcohol/urea-formaldehyde resin in furfuryl alcohol), to give a content by percentage of 3% by weight. The content by percentage of free furfuryl alcohol in the furan resin A was 72% by weight, and that of a silane coupling agent (N-β-(aminoethyl)-γ-aminopropylmethyldimethoxysilane) therein was 0.1% by weight. The nitrogen content by percentage in the furan resin A was 1.8% by weight, and the water content by percentage in the furan resin A was 3.4% by weight. The viscosity of the furan resin A was 17 mPa·s (25° C.). Respective methods for measuring the nitrogen content by percentage, the water content by percentage, and The viscosity are described below.

<Nitrogen Content by Percentage in Furan Resin A>

The content by percentage was measured on the basis of Kjeldahl method described in JIS M 8813.

<Water Content by Percentage in Furan Resin A>

The content by percentage was measured on the basis of Karl Fisher Method described in JIS K 0068.

<Viscosity of Furan Resin>

The viscosity was measured on the basis of a viscosity measuring manual attached to a BM type viscometer manufactured by Tokyo Keiki Inc.

### Preparation of Binder Compositions of Examples 1 to 37 and Comparative Examples 1 to 9

Components for each of binder compositions shown in Tables 1 to 3 were mixed with each other in accordance with respective blend amounts thereof. In this way, the binder compositions were prepared. In each of the working examples and the comparative examples, a compound used was a reagent manufactured by Wako Pure Chemical Industries, Ltd. The purity (%) of each of the metal compounds shown in Tables 1 to 3 was a value described in catalogues of reagents manufactured by Wako Pure Chemical Industries, Ltd. The respective contents by percentage of the components in each of the binder compositions shown in Tables 1 to 3 are contents by percentage in the binder composition (100% by weight).

About calcium p-tolunesulfonate, which was a metal compound in each of Examples 11 and 35, 100 g of an aqueous solution wherein calcium hydroxide was dispersed at a concentration of 0.1 mole/liter was mixed with 100 g of an aqueous solution of p-toluenesulfonic acid having a concentration of 0.2 mole/liter at normal temperature; this solution was shifted into a petri dish having a diameter of 300 mm; and then the shifted solution was dried in a drying machine of 120° C. temperature for 24 hours. Thereafter, 10 g of the dried cake was scratched out, and then pulverized in a mortar made of agate. In this way, calcium p-tolunesulfonate in a white powdery form was yielded. About the purity of this metal compound, Ca element therein was analyzed on the basis of “ICP Emission Spectroscopic Analysis” in JIS-K0116, and then the purity of the calcium p-tolunesulfonate sample was calculated out.

About calcium m-xylenesulfonate, which was a metal compound in each of Examples 12 and 36, in the same way, 100 g of an aqueous solution wherein calcium hydroxide was dispersed at a concentration of 0.1 mole/liter was mixed with 100 g of an aqueous solution of m-xylenesulfonic acid, the concentration of which was 0.2 mole/liter, at normal temperature; this solution was shifted into a petri dish having a diameter of 300 mm; and then the shifted solution was dried in a drying machine of 120° C. temperature for 24 hours. Thereafter, 10 g of the dried cake was scratched out, and then pulverized in a mortar made of agate. In this way, calcium m-xylenesulfonate in a white powdery form was yielded. About the purity of this metal compound, the same operation as described above was made, and then the purity of the calcium m-xylenesulfonate sample was calculated out.

### Preparation of Mold Manufacturing Compositions of Examples 1 to 30, and Comparative Examples 1, and 4 to 9

At 25° C. and a relative humidity of 60%, to 2 kg of silica sand [FREE MANTLE NEW SAND, manufactured by Yamakawa Sangyo Co., Ltd.] were added 8.0 g of a curing agent containing xylenesulfonic acid and sulfuric acid [mixture of 4.0 g of a curing agent, KAO LIGHTNER TK-1 manufactured by Kao-Quaker Co., Ltd., and 4.0 g of another curing agent, KAO LIGHTNER EC-11 manufactured by Kao-Quaker Co., Ltd.] (sulfur content by percentage: 9.9% by weight). Thereafter, the components were kneaded, and next thereto was added 20.0 g of each binder composition shown in Tables 1 and 2. These combined components were mixed with each other to yield each mold manufacturing composition (molding sand). In each of Tables 1 and 2, the item “Mole ratio (M/S)” represents the ratio by mole of metal element M of the metal compound in the binder composition to sulfur element S in the curing agent. This matter is the same as in Examples 31 to 37, which will be described later. The content by percentage of sulfur element S contained in the curing agent was measured in accordance with a method described below.

<Analysis of Sulfur Element>

One gram of a sample was weighed, and then put into a 200-mL conical beaker, and thereto were added 1 mL of 30% by weight hydrogen peroxide water and 10 mL of nitric acid. A hot plate was used to heat this mixture at 200 to 300° C. to decompose the sample until the initial volume was reduced into half or less. The system was naturally cooled, and thereto was added 10 mL of nitric acid. The mixture was further heated at 200 to 300° C. to decompose the sample. Subsequently, the system was naturally cooled, and thereto were added 35% by weight hydrochloric acid (2 mL) and pure water (30 mL). The mixture was heated at 200 to 300° C. to decompose the sample. The system was naturally cooled. Thereafter, about the sample, the volume of which was increased up to a predetermined quantity (50 mL), the content by percentage of sulfur element therein was measured by a “Shimadzu twin sequential type high-frequency plasma emission spectroscopic analyzer, ICPS-8100” manufactured by Shimadzu Corp. on the basis of “ICP Emission Spectroscopic Analysis” in JIS-K0116. For reference, the sample was pre-treated on the basis of JIS-K0102, and the sample solution was prepared on the basis of JIS-K0083. The number of times of the measurement was set to 2, and the average of values therein was calculated out.

### Preparation of Mold Manufacturing Compositions of Comparative Examples 2 and 3

A mold manufacturing composition (molding sand) of Comparative Example 2 was yielded in the same way as in Comparative Example 1 except that 0.1 part by weight of anhydrous sodium carbonate was further added to 100 parts by weight of the silica sand [FREE MANTLE NEW SAND, manufactured by Yamakawa Sangyo Co., Ltd.]. Moreover, a mold manufacturing composition (molding sand) of Comparative Example 3 was yielded in the same way as in Comparative Example 1 except that 0.1 part by weight of anhydrous calcium chloride was further added to 100 parts by weight of the silica sand [FREE MANTLE NEW SAND), manufactured by Yamakawa Sangyo Co., Ltd.].

### Preparation of Mold Manufacturing Compositions of Examples 31 to 37

At 25° C. and a relative humidity of 60%, to 2 kg of silica sand [FREE MANTLE NEW SAND, manufactured by Yamakawa Sangyo Co., Ltd.] were added 8.0 g of a curing agent containing xylenesulfonic acid, sulfuric acid and phosphoric acid [mixture of 4.4 g of a curing agent, KAO LIGHTNER NC-501 manufactured by Kao-Quaker Co., Ltd., and 3.6 g of another curing agent, KAO LIGHTNER NC-521 manufactured by Kao-Quaker Co., Ltd.] (sulfur content by percentage: 4.29% by weight; and phosphorous content by percentage: 13.77% by weight). Thereafter, the components were kneaded, and next thereto was added 20.0 g of each binder composition shown in Table 3. These combined components were mixed with each other to yield each mold manufacturing composition (molding sand). In Table 3, the item “Mole ratio (P/S)” represents the ratio by mole of phosphorous element P in the curing agent to sulfur element Sin the curing agent (P/S). The content by percentage of sulfur element S in the curing agent was measured in the same manner as described above, and the content by percentage of phosphorous element P in the curing agent was measured in a manner described below.

<Analysis of Phosphorous Element>

One gram of a sample was weighed, and then put into a 200-mL conical beaker, and thereto was added 10 mL of nitric acid. A hot plate was used to heat this mixture at 200 to 300° C. to decompose the sample until the initial volume was reduced into half or less. The system was naturally cooled, and thereto was added 10 mL of nitric acid. The mixture was further heated at 200 to 300° C. to decompose the sample. Subsequently, the system was naturally cooled, and thereto were added 35% by weight hydrochloric acid (2 mL) and pure water (30 mL). The mixture was heated at 200 to 300° C. to decompose the sample. The system was naturally cooled. Thereafter, about the sample, the volume of which was increased up to a predetermined quantity (50 mL), the content by percentage of phosphorous element therein was measured by a “Shimadzu twin sequential type high-frequency plasma emission spectroscopic analyzer, ICPS-8100” manufactured by Shimadzu Corp. on the basis of “ICP Emission Spectroscopic Analysis” in JIS-K0116. For reference, the sample was pre-treated on the basis of JIS-K0102, and the sample solution was prepared on the basis of JIS-K0083. The number of times of the measurement was set to 2, and the average of values therein was calculated out.

About the resultant mold manufacturing compositions, evaluations described below were made. The results are shown in Tables 1 to 3.

<Mold Strength (σa)>

Each of the mold manufacturing compositions just after the kneading was filled into a test piece frame in the form of a column having a diameter of 50 mm and a height of 50 mm. When 5 hours elapsed after the filling, the composition was taken out from the frame. The composition was allowed to stand still at 25° C. and a relative humidity of 60% for 48 hours, and then the compression strength thereof was measured by a method described in JIS Z 2604-1976. The resultant measured value was defined as the mold strength (σa).

<Mold Strength (σb)>

Each of the mold manufacturing compositions just after the kneading was filled into a test piece frame in the form of a column having a diameter of 50 mm and a height of 50 mm. When 5 hours elapsed after the filling, the composition was taken out from the frame. The composition was allowed to stand still at 25° C. and a relative humidity of 60% for 24 hours, and subsequently allowed to stand still at 25° C. and a relative humidity of 85% for 24 hours. The compression strength thereof was then measured by the method described in JIS Z 2604-1976. The resultant measured value was defined as the mold strength (σb).

<Mold Strength Maintenance Factor (%)>

The mold strength maintenance factor (of the sample) was calculated in accordance with an equation described below. As a sample has a higher mold strength maintenance factor, the sample has a higher performance capable of maintaining the mold strength in a high-humidity environment.

Mold strength maintenance factor (%)=σb/σa×100

<Measurement of Generated Amount of Decomposition Gas>

The same test pieces as used to evaluate the mold strength (σa) were ribbed onto each other over a 20-mesh sieve made of stainless steel to be forcibly smashed, and 5.00 g of the resultant molding sand was filled into a burning ceramic boat (manufactured by MM Kagaku Togyo-sha; mode: 997-CB-2; and width of 15 mm, height of 10 mm, and length of 90 mm) to prepare a measuring sample. Thereafter, the measuring sample was inserted into a central region of a heater in a ring furnace (manufactured by Advantec Tokyo-sha; type: 07-V9:9kW; ring furnace inside diameter: 60 mm; length: 600 mm; and one of its parts: aluminum foil shielded), the temperature of which was adjusted to 500° C. In a predetermined measuring period described below, the respective concentrations of hydrogen chloride gas and sulfur dioxide gas generated when the sample was burned were measured by means of a gas detector (manufactured by Gastec Corp.; model: GV-100S) (using a detecting tube species 14L for the former gas, and using a detecting tube species 5L in each of Examples 1 to 30 and Comparative Examples 1 to 9 or a detecting tube species 5La in each of Examples 30 to 37 for the latter gas). In Tables 1 to 3, each symbol “-” in the columns “Hydrogen chloride gas” represents a case where no hydrogen chloride gas was detected. The time when each of the gas detecting tubes was measured was set as follows:

Case of hydrogen chloride gas: over 1 minute from the time when 0.5minute elapsed after the measuring sample was inserted, the gas was once collected. Over 1 minute from the time when 2 minutes elapsed after the insertion, the gas was once collected. The respective values measured about the collected samples were summed.

Case of sulfur dioxide gas: over 1 minute from the time when 0.5minute elapsed after the measuring sample was inserted, the gas was once collected. Over 1 minute from the time when 2 minutes elapsed after the insertion, the gas was once collected. Over 1 minute from the time when 4 minutes elapsed after the insertion, the gas was once collected. Over 1 minute from the time when 6 minutes elapsed after the insertion, the gas was once collected. The respective values measured about the collected samples were summed (however, in any case where sulfur dioxide gas was measured, using the detecting tube species 5La, a value obtained by doubling a value indicating each of the detected concentrations was adopted).

<Evaluation of Sensorily Irritating Smell>

In the same manner as described in the above-mentioned item <Measurement of Generated Amount of Decomposition Gas>, a measuring sample was inserted into a central region of a heater in a ring furnace. After 2 minutes elapsed from the insertion of the sample, 100 mL of generated gas was collected, and put into a tetra pack for gas-collection. The gas was diluted 30 times with a fresh air to set the total volume to 3.0 liters. Next, about the gas inside the tetra pack, respective sensorily irritating smells of hydrogen chloride gas and sulfur dioxide gas were inspected (by three inspectors). The sample was evaluated in accordance with the following ranks (A to F) (about each of the gases).

A: the three hardly felt the irritating smell.

B: one of the three slightly felt the irritating smell.

C: two of the three slightly felt the irritating smell.

D: the three slightly felt the irritating smell.

E: the three felt the irritating smell.

F: the three intensely felt the irritating smell.

TABLE 1

| | Binder composition | | | | | Mold manufacturing composition | | |
|---|---|---|---|---|---|---|---|---|
| | | Metal compound | | | Metal | | Part by | |
| Working | Furan resin | | Metal | | element content | | weight of metal | |
| Examples and | Furan resin | | compound | Metal | (% by weight) | Added | compound added | Mole |
| Comparative | A content | | content (% | compound | in binder | metal | to 100 parts by | ratio |
| Examples | (% by weight) | Compound | by weight) | purity (%) | composition | compound | weight of sand | (M/S) |

| | | | | | | | |
|---|---|---|---|---|---|---|---|
| Example 1 | 99.31 | Calcium hydroxide | 0.69 | 96.0 | 0.36 | None | 0.073 |
| Example 2 | 99.09 | Magnesium hydroxide | 0.91 | 95.0 | 0.36 | None | 0.120 |
| Example 3 | 98.90 | Aluminum hydroxide | 1.10 | 95.0 | 0.36 | None | 0.108 |
| Example 4 | 99.49 | Calcium oxide | 0.51 | 98.0 | 0.36 | None | 0.073 |
| Example 5 | 99.39 | Magnesium oxide | 0.61 | 98.0 | 0.36 | None | 0.120 |
| Example 6 | 97.85 | Calcium nitrate | 2.15 | 98.5 | 0.36 | None | 0.073 |
| | | tetrahydrate | | | | | |
| Example 7 | 96.18 | Magnesium nitrate | 3.82 | 99.0 | 0.36 | None | 0.120 |
| | | hexahydrate | | | | | |
| Example 8 | 94.89 | Aluminum nitrate | 5.11 | 98.0 | 0.36 | None | 0.108 |
| | | nonahydrate | | | | | |
| Example 9 | 98.82 | Calcium formate | 1.18 | 99.0 | 0.36 | None | 0.073 |
| Example 10 | 96.82 | Calcium benzoate | 3.18 | 95.0 | 0.36 | None | 0.073 |
| | | trihydrate | | | | | |
| Example 11 | 96.47 | Calcium | 3.53 | 98.0 | 0.36 | None | 0.073 |
| | | p-toluenesulfonate | | | | | |
| Example 12 | 96.21 | Calcium | 3.79 | 98.0 | 0.36 | None | 0.073 |
| | | xylenesulfonate | | | | | |
| Example 13 | 98.04 | Acetylacetate | 1.96 | 98.0 | 0.36 | None | 0.032 |
| | | zirconium | | | | | |
| Example 14 | 98.82 | Manganese (II) | 1.18 | 96.0 | 0.36 | None | 0.053 |
| | | acetate | | | | | |
| Example 15 | 99.02 | Nickel (II) | 0.98 | 95.0 | 0.36 | None | 0.050 |
| | | hydroxide | | | | | |
| Example 16 | 99.44 | Copper (II) | 0.56 | 98.0 | 0.36 | None | 0.046 |
| | | hydroxide | | | | | |
| Example 17 | 95.72 | Aluminum | 4.28 | 94.2 | 0.36 | None | 0.108 |
| | | (s-butoxide) | | | | | |
| | | acetoacetate | | | | | |
| Example 18 | 96.63 | Magnesium | 3.37 | 98.0 | 0.36 | None | 0.120 |
| | | acetylacetone | | | | | |

| Comparative | 100.00 | Not contained | None | | 0.000 |
|---|---|---|---|---|---|
| Example 1 | | | | | |
| Comparative | 100.00 | Not contained | Anhydrous | 0.1 | 0.000 |
| Example 2 | | | sodium | | |
| | | | carbonate | | |
| Comparative | 100.00 | Not contained | Anhydrous | 0.1 | 0.000 |
| Example 3 | | | calcium | | |
| | | | chloride | | |

| | | | | | | | |
|---|---|---|---|---|---|---|---|
| Comparative | 98.67 | Calcium chloride | 1.33 | 99.0 | 0.36 | None | 0.073 |
| Example 4 | | dihydrate | | | | | |
| Comparative | 96.00 | Calcium chloride | 4.00 | 99.0 | 1.08 | None | 0.219 |
| Example 5 | | dihydrate | | | | | |

| | | | | Decomposition gas | | | |
|---|---|---|---|---|---|---|---|
| | Mold strength properties | | | generated amount | | | |
| Working | Mold | Mold | Mold strength | Hydrogen | Sulfur | Sensorily irritating | |
| Examples and | strength | strength | maintenance | chloride | dioxide | smell evaluation | |
| Comparative | (σa) | (σb) | factor | gas | gas | Hydrogen | Sulfur |
| Examples | (MPa) | (MPa) | (%) | (ppm) | (ppm) | chloride gas | dioxide gas |
| Example 1 | 6.30 | 5.82 | 92.4 | — | 59 | A | B |
| Example 2 | 6.10 | 5.45 | 89.3 | — | 61 | A | B |
| Example 3 | 6.03 | 5.10 | 84.6 | — | 65 | A | C |
| Example 4 | 6.05 | 5.10 | 84.3 | — | 62 | A | B |
| Example 5 | 6.00 | 5.04 | 84.0 | — | 66 | A | C |
| Example 6 | 6.10 | 5.60 | 91.8 | — | 55 | A | B |
| Example 7 | 6.04 | 5.55 | 91.9 | — | 56 | A | B |
| Example 8 | 6.01 | 5.48 | 91.2 | — | 55 | A | B |
| Example 9 | 6.00 | 5.06 | 84.3 | — | 60 | A | B |
| Example 10 | 6.27 | 5.40 | 86.1 | — | 60 | A | B |
| Example 11 | 6.20 | 5.70 | 91.9 | — | 60 | A | B |
| Example 12 | 6.12 | 5.56 | 92.5 | — | 62 | A | B |
| Example 13 | 6.05 | 4.90 | 81.0 | — | 64 | A | C |
| Example 14 | 6.00 | 5.30 | 88.3 | — | 62 | A | C |
| Example 15 | 6.14 | 5.52 | 89.9 | — | 62 | A | B |
| Example 16 | 6.00 | 5.30 | 88.3 | — | 62 | A | C |
| Example 17 | 7.10 | 5.90 | 83.1 | — | 57 | A | B |
| Example 18 | 7.10 | 5.90 | 83.1 | — | 59 | A | B |
| Comparative | 5.60 | 4.42 | 78.9 | — | 102 | A | F |
| Example 1 | | | | | | | |
| Comparative | 5.10 | 3.83 | 75.1 | — | 90 | A | E |
| Example 2 | | | | | | | |
| Comparative | 5.15 | 3.64 | 70.7 | 25 | 65 | F | D |
| Example 3 | | | | | | | |
| Comparative | 5.32 | 4.22 | 79.3 | 4 | 75 | D | E |
| Example 4 | | | | | | | |
| Comparative | 5.31 | 4.11 | 77.4 | 10 | 65 | E | D |
| Example 5 | | | | | | | |

TABLE 2

| | Binder composition | | | | | Mold |
|---|---|---|---|---|---|---|
| Working | Furan resin | Metal compound | | | | manufacturing |
| Examples and | Furan resin | | Metal | Metal | Metal element content | composition |
| Comparative | A content | | compound content | compound | (% by weight) in | Mole ratio |
| Examples | (% by weight) | Compound | (% by weight) | purity (%) | binder composition | (M/S) |
| Example 19 | 99.98 | Calcium hydroxide | 0.02 | 96.0 | 0.01 | 0.002 |
| Example 20 | 99.81 | Calcium hydroxide | 0.19 | 96.0 | 0.10 | 0.020 |
| Example 1 | 99.31 | Calcium hydroxide | 0.69 | 96.0 | 0.36 | 0.073 |
| Example 21 | 98.65 | Calcium hydroxide | 1.35 | 96.0 | 0.70 | 0.141 |
| Comparative | 98.07 | Calcium hydroxide | 1.93 | 96.0 | 1.00 | 0.202 |
| Example 6 | | | | | | |
| Example 22 | 99.97 | Magnesium hydroxide | 0.03 | 95.0 | 0.01 | 0.003 |
| Example 23 | 99.75 | Magnesium hydroxide | 0.25 | 95.0 | 0.10 | 0.033 |
| Example 2 | 99.09 | Magnesium hydroxide | 0.91 | 95.0 | 0.36 | 0.120 |
| Example 24 | 98.24 | Magnesium hydroxide | 1.76 | 95.0 | 0.70 | 0.233 |
| Comparative | 97.48 | Magnesium hydroxide | 2.52 | 95.0 | 1.00 | 0.332 |
| Example 7 | | | | | | |
| Example 25 | 99.94 | Calcium nitrate | 0.06 | 98.5 | 0.01 | 0.002 |
| | | tetrahydrate | | | | |
| Example 26 | 99.40 | Calcium nitrate | 0.60 | 98.5 | 0.10 | 0.020 |
| | | tetrahydrate | | | | |
| Example 6 | 97.85 | Calcium nitrate | 2.15 | 98.5 | 0.36 | 0.073 |
| | | tetrahydrate | | | | |
| Example 27 | 95.81 | Calcium nitrate | 4.19 | 98.5 | 0.70 | 0.141 |
| | | tetrahydrate | | | | |
| Comparative | 94.02 | Calcium nitrate | 5.98 | 98.5 | 1.00 | 0.202 |
| Example 8 | | pentahydrate | | | | |
| Example 28 | 99.88 | Aluminum | 0.12 | 94.2 | 0.01 | 0.003 |
| | | di(s-butoxide)ac- | | | | |
| | | etoacetate | | | | |
| Example 29 | 98.81 | Aluminum | 1.19 | 94.2 | 0.10 | 0.030 |
| | | di(s-butoxide)ac- | | | | |
| | | etoacetate | | | | |
| Example 17 | 95.72 | Aluminum | 4.28 | 94.2 | 0.36 | 0.108 |
| | | di(s-butoxide)ac- | | | | |
| | | etoacetate | | | | |
| Example 30 | 91.67 | Aluminum | 8.33 | 94.2 | 0.70 | 0.210 |
| | | di(s-butoxide)ac- | | | | |
| | | etoacetate | | | | |
| Comparative | 88.10 | Aluminum | 11.90 | 94.2 | 1.00 | 0.300 |
| Example 9 | | di(s-butoxide)ac- | | | | |
| | | etoacetate | | | | |

| | | | |
|---|---|---|---|
| Comparative | 100.00 | Not contained | 0.000 |
| Example 1 | | | |

| | Mold strength properties | | | Decomposition gas | | | |
|---|---|---|---|---|---|---|---|
| Working | Mold | Mold | Mold strength | generated amount | | Sensorily irritating | |
| Examples and | strength | strength | maintenance | Hydrogen | Sulfur | smell evaluation | |
| Comparative | (σa) | (σb) | factor | chloride gas | dioxide gas | Hydrogen | Sulfur |
| Examples | (MPa) | (MPa) | (%) | (ppm) | (ppm) | chloride gas | dioxide gas |
| Example 19 | 5.95 | 5.41 | 90.9 | — | 75 | A | D |
| Example 20 | 6.12 | 5.60 | 91.5 | — | 68 | A | C |
| Example 1 | 6.30 | 5.82 | 92.4 | — | 59 | A | B |
| Example 21 | 6.23 | 5.61 | 90.0 | — | 44 | A | B |
| Comparative | 5.40 | 4.30 | 79.6 | — | 40 | A | D |
| Example 6 | | | | | | | |
| Example 22 | 5.80 | 5.10 | 87.9 | — | 82 | A | D |
| Example 23 | 5.98 | 5.28 | 88.3 | — | 77 | A | D |
| Example 2 | 6.10 | 5.45 | 89.3 | — | 61 | A | B |
| Example 24 | 5.98 | 5.30 | 88.6 | — | 49 | A | B |
| Comparative | 5.00 | 3.91 | 78.2 | — | 44 | A | B |
| Example 7 | | | | | | | |
| Example 25 | 5.92 | 5.30 | 89.5 | — | 77 | A | D |
| Example 26 | 6.02 | 5.45 | 90.5 | — | 68 | A | C |
| Example 6 | 6.10 | 5.60 | 91.8 | — | 55 | A | B |
| Example 27 | 5.93 | 5.27 | 88.9 | — | 42 | A | B |
| Comparative | 5.12 | 4.00 | 78.1 | — | 39 | A | B |
| Example 8 | | | | | | | |
| Example 28 | 6.00 | 4.82 | 80.3 | — | 78 | A | D |
| Example 29 | 7.23 | 5.86 | 81.1 | — | 73 | A | D |
| Example 17 | 7.10 | 5.93 | 83.1 | — | 57 | A | B |
| Example 30 | 6.52 | 5.30 | 81.3 | — | 44 | A | B |
| Comparative | 5.60 | 4.42 | 78.9 | — | 40 | A | B |
| Example 9 | | | | | | | |
| Comparative | 5.60 | 4.42 | 78.9 | | 102 | A | F |
| Example 1 | | | | | | | |

TABLE 3

| | Binder composition | | | | | | | | | | |
|---|---|---|---|---|---|---|---|---|---|---|---|
| | | | | | Metal | | | Decomposition | | | |
| | | | | | element | Mold | | gas generated | | Sensorily | |
| | | Metal compound | | | content | manufacturing | | amount | | irritating smell | |
| Working | Furan resin | | Metal | Metal | (% by | composition | | Hydrogen | Sulfur | evaluation | |
| Examples and | Furan resin | | compound | compound | weight) | Mole | Mole | chloride | dioxide | Hydrogen | Sulfur |
| Comparative | A content (% | | content (% | purity | in binder | ratio | ratio | gas | gas | chloride | dioxide |
| Examples | by weight) | Compound | by weight) | (%) | composition | (M/S) | (P/S) | (ppm) | (ppm) | gas | gas |
| Example 31 | 99.31 | Calcium hydroxide | 0.69 | 96.0 | 0.36 | 0.165 | 3.330 | — | 28 | A | A |
| Example 32 | 99.49 | Calcium oxide | 0.51 | 98.0 | 0.36 | 0.165 | 3.330 | — | 32 | A | A |
| Example 33 | 97.85 | Calcium nitrate | 2.15 | 98.5 | 0.36 | 0.165 | 3.330 | — | 30 | A | A |
| | | tetrahydrate | | | | | | | | | |
| Example 34 | 96.82 | Calcium benzoate | 3.18 | 95.0 | 0.36 | 0.165 | 3.330 | — | 30 | A | A |
| | | trihydrate | | | | | | | | | |
| Example 35 | 96.47 | Calcium | 3.53 | 98.0 | 0.36 | 0.165 | 3.330 | — | 33 | A | A |
| | | p-toluenesulfonate | | | | | | | | | |
| Example 36 | 96.21 | Calcium | 3.79 | 98.0 | 0.36 | 0.165 | 3.330 | — | 33 | A | A |
| | | xylenesulfonate | | | | | | | | | |
| Example 37 | 95.72 | Aluminum | 4.28 | 94.2 | 0.36 | 0.249 | 3.330 | — | 30 | A | A |
| | | di(s-butoxide)ac- | | | | | | | | | |
| | | etoacetate | | | | | | | | | |
| Example 1 | 99.31 | Calcium hydroxide | 0.69 | 96.0 | 0.36 | 0.073 | 0.000 | — | 59 | A | B |
| Example 4 | 99.49 | Calcium oxide | 0.51 | 98.0 | 0.36 | 0.073 | 0.000 | — | 62 | A | B |
| Example 6 | 97.85 | Calcium nitrate | 2.15 | 98.5 | 0.36 | 0.073 | 0.000 | — | 55 | A | B |
| | | tetrahydrate | | | | | | | | | |
| Example 10 | 96.82 | Calcium benzoate | 3.18 | 95.0 | 0.36 | 0.073 | 0.000 | — | 60 | A | B |
| | | trihydrate | | | | | | | | | |
| Example 17 | 95.72 | Aluminum | 4.28 | 94.2 | 0.36 | 0.108 | 0.000 | — | 57 | A | B |
| | | di(s-butoxide)ac- | | | | | | | | | |
| | | etoacetate | | | | | | | | | |
| Comparative | 100.00 | Not contained | | | | 0.000 | 0.000 | — | 102 | A | F |
| Example 1 | | | | | | | | | | | |
| Comparative | 98.67 | Calcium chloride | 1.33 | 99.0 | 0.36 | 0.073 | 0.000 | 4 | 75 | D | E |
| Example 4 | | dihydrate | | | | | | | | | |

As shown in Tables 1 to 3, in the working examples, a good result was obtained about each of the evaluating items. However, in the comparative examples, a remarkably poorer result was obtained than in the working examples about at least one of the evaluating items. From this result, it was verified that the invention makes it possible to supply a binder composition for use in mold manufacturing capable of preventing a deterioration in the mold strength in a high-humidity environment and further restraining the generation of irritant gas at the time of casting.

1-9. (canceled)

10. A binder composition for use in mold manufacturing, comprising a furan resin, and a metal compound containing one or more metal elements selected from the group consisting of elements in the Groups 2, 4, 7, 10, 11 and 13 of the periodic table,
wherein the content by percentage of the metal element(s) in the binder composition is from 0.01 to 0.70% by weight, and
the metal compound is one or more metal compounds selected from hydroxides, nitrates, oxides, organic acid salts, alkoxides, and ketone complexes.

11. The binder composition for use in mold manufacturing according to claim 10, wherein the metal compound is a metal compound containing one or more metal elements selected from the group consisting of elements in the Group 2 of the period table.

12. The binder composition for use in mold manufacturing according to claim 10, wherein the metal compound is a metal compound containing one or more metal elements selected from the group consisting of Mg and Ca.

13. The binder composition for use in mold manufacturing according to claim 10, wherein the metal compound is a hydroxide.

14. The binder composition for use in mold manufacturing according to claim 10, wherein the metal compound is a hydroxide, and the content by percentage of the metal compound is from 0.50 to 1.80% by weight.

15. The binder composition for use in mold manufacturing according to claim 10, wherein the content by percentage of the metal element(s) is from 0.30 to 0.70% by weight.

16. The binder composition for use in mold manufacturing according to claim 10, wherein the content by percentage of the metal element(s) is from 0.30 to 0.40% by weight.

17. The binder composition for use in mold manufacturing according to claim 10, wherein the furan resin comprises one or more selected from the group consisting of furfuryl alcohol, any condensate from furfuryl alcohol, any condensate from furfuryl alcohol and an aldehyde, any condensate from furfuryl alcohol and urea, any condensate from furfuryl alcohol, a phenolic compound, and an aldehyde, any condensate from furfuryl alcohol, melamine, and an aldehyde, and any condensate from furfuryl alcohol, urea, and an aldehyde; or comprises a co-condensate of two or more selected from this group.

18. The binder composition for use in mold manufacturing according to claim 10, wherein the furan resin comprises one or more selected from the group consisting of furfuryl alcohol, and any condensate from furfuryl alcohol, urea, and formaldehyde.

19. A mold manufacturing composition, comprising a mixture of fire-resistant particles, the binder composition for use in mold manufacturing recited in claim 10, and a curing agent for furan resin that is to cure the binder composition for use in mold manufacturing.

20. The mold manufacturing composition according to claim 19, wherein the amount of the binder composition for use in mold manufacturing and that of the curing agent for furan resin are from 0.5 to 1.5 parts by weight and from 0.07 to 1 part by weight, respectively, for 100 parts by weight of the fire-resistant particles.

21. The mold manufacturing composition according to claim 19, wherein the curing agent for furan resin comprises a sulfur compound, and
the metal element(s) in the binder composition for use in mold manufacturing is/are contained in an amount of 0.0005 to 0.4 moles per mole of the sulfur element in the curing agent for furan resin.

22. The mold manufacturing composition according to claim 21, wherein the metal element(s) in the binder composition for use in mold manufacturing is/are contained in an amount of 0.005 to 0.2 moles per mole of a sulfur element in the curing agent for furan resin.

23. The mold manufacturing composition according to claim 19, wherein the curing agent for furan resin further comprises a phosphoric acid compound.

24. The mold manufacturing composition according to claim 23, wherein the ratio by mole of the phosphorous element in the phosphoric acid compound to the sulfur element in the sulfur compound (phosphorous/sulfur) is from 1 to 5.

25. A method for manufacturing a mold, which comprises filling, into an original pattern for mold manufacturing, a mold manufacturing composition comprising a mixture of fire-resistant particles, a binder composition for use in mold manufacturing, and a curing agent for furan resin that is to cure the binder composition for use in mold manufacturing, thereby curing the mold manufacturing composition,
wherein the binder composition for use in mold manufacturing comprises a furan resin, and a metal compound containing one or more metal elements selected from the group consisting of elements in the Groups 2, 4, 7, 10, 11 and 13 of the periodic table,
the content by percentage of the metal element(s) in the binder composition is from 0.01 to 0.70% by weight, and
the metal compound is one or more metal compounds selected from hydroxides, nitrates, oxides, organic acid salts, alkoxides, and ketone complexes.

26. The mold manufacturing method according to claim 25, wherein the metal compound is a metal compound containing one or more metal elements selected from the group consisting of elements in the Group 2 of the period table.

27. The mold manufacturing method according to claim 25, wherein the metal compound is one or more of the hydroxides.

28. The mold manufacturing method according to claim 25, wherein the content by percentage of the metal element(s) is from 0.30 to 0.70% by weight.

29. The mold manufacturing method according to claim 25, wherein the furan resin comprises one or more selected from the group consisting of furfuryl alcohol, any condensate from furfuryl alcohol, any condensate from furfuryl alcohol and an aldehyde, any condensate from furfuryl alcohol and urea, any condensate from furfuryl alcohol, a phenolic compound, and an aldehyde, any condensate from furfuryl alcohol, melamine, and an aldehyde, and any condensate from furfuryl alcohol, urea, and an aldehyde; or comprises a co-condensate of two or more selected from this group.
